(19) United States
(12) Patent Application Publication
(10) Pub. No.: US 2015/0009145 A1
(43) Pub. Date: Jan. 8, 2015

(54) INTERACTION PERIPHERAL DEVICE CAPABLE OF CONTROLLING AN ELEMENT FOR TOUCHING AND GRASPING MULTIDIMENSIONAL VIRTUAL OBJECTS

(71) Applicants: Jean-Rémy Kouni Edward Grégoire Chardonnet, Chalon Sur Saone (FR); Jean-Claude Leon, Gieres (FR)

(72) Inventors: Jean-Rémy Kouni Edward Grégoire Chardonnet, Chalon Sur Saone (FR); Jean-Claude Leon, Gieres (FR)

(21) Appl. No.: 14/374,932

(22) PCT Filed: Jan. 31, 2013
(86) PCT No.: PCT/EP2013/051954

§ 371 Date: Jul. 28, 2014

(30) Foreign Application Priority Data
Jan. 31, 2012 (FR) 1250878

(51) Int. Cl. G06F 3/01; G05G 9/047; G06F 3/0338

(52) U.S. Cl. CPC G06F 3/011; G06F 3/016; G06F 3/0338; G05G 9/047; G05G 2009/04766; G06F 2203/015
USPC 345/161

(57) ABSTRACT

An interaction peripheral device (1) capable of controlling an element for touching and grasping multidimensional virtual objects, including at least two interaction modules (20), each interaction module (20) being intended to be actuated by a finger of an operator and including a control sensor allowing control of displacement, according to a predetermined number of degrees of freedom, of a portion of the element for touching and grasping virtual objects by bending/extending and/or adduction/abduction displacement of the finger of the operator, and a vibrator able to emit a vibration upon touching and/or letting go of a virtual object by a portion of said element for touching and grasping virtual objects, characterized in that each interaction module (20) is attached to said peripheral device through a connection (40) in a damping material.

The present invention relates to an interaction peripheral device capable of controlling an element for touching and grasping multidimensional virtual objects.

The invention belongs to the field of user interfaces, in particular developed user interfaces for an immersion in virtual environments.

The invention finds applications in many fields using virtual environments, for example physical and medical simulation, industrial processes, remote operation.

With the development of the capability of modeling and displaying objects and virtual scenes, many solutions have been proposed for facilitating the handling of objects in virtual environments, in particular by transforming the movements of a real hand into the movements of a virtual hand, in order to make the handling more ergonomic.

Diverse interaction peripheral devices have been developed, allowing control of multidimensional virtual objects, based on systems for optical capture of movements, for example via cameras, or on systems for mechanical capture, for example gloves provided with sensors. The performance of optical capture systems is strongly dependent on the number and on the position of the cameras. As regards the mechanical capture systems including gloves, their calibration is very sensitive, and therefore they are not very suitable for massive usage.

Further, these systems are not ergonomic since they require freehand manipulations to be performed, which is tiring for an operator.

Moreover peripheral devices close to the mouse customarily used with computers are known, such as for example the SpaceNavigator (registered trademark) peripheral device which has a maximum of six degrees of freedom. Such a peripheral is well adapted for pointing tasks or complex manipulations of three-dimensional objects.

In particular, a peripheral such as the SpaceNavigator (registered trademark) does not provide any haptic or pseudo-haptic return, allowing an operator to experience a tactile contact sensation, similar to the touch sensation with a real object. The term of pseudo-haptic designates the fact that tactile return is not directly correlated with the mass of the manipulated object.

The inventors have described in the article “Un périphérique pour la saisie d'objets avec retour tactile” (a peripheral device for grasping objects with tactile return), published in 2010, 5èmes Journées de l'Association Francaise de la Réalité Virtuelle, an interaction peripheral device with pseudo-haptic return with bare hands. This is an interaction peripheral device capable of controlling a virtual hand, consisting of interaction modules, one module allowing control of one or several fingers. Each module includes a vibrator capable of emitting a vibration upon touching a virtual object with the virtual finger actuated by the module. This interaction peripheral device is ergonomic since it may be actuated by an operator's hand laid thereon, which avoids muscular fatigue of the operator. A vibrator is integrated into each module so as to produce a pseudo-haptic return upon touching or grasping virtual objects, allowing the operator to better manipulate three-dimensional virtual objects. However, the pseudo-haptic return produced in the peripheral device described in this article is diffuse and does not allow the operator to fully use it in order to improve manipulation of virtual objects.

Therefore there exists a need for finding a remedy to this drawback by improving the accuracy of the haptic or pseudo-haptic return of an interaction peripheral device of the type described above.

For this purpose, the invention proposes an interaction peripheral device capable of controlling an element for touching and grasping multidimensional virtual objects, including at least two interaction models, each interaction module being intended to be actuated by a finger of an operator and including a control sensor allowing to control a displacement, according to a predetermined number of degrees of freedom, of a portion of the element for touching and grasping virtual objects by a bending/extending displacement and/or adduction/abduction of the finger of the operator and a vibrator capable of emitting a vibration upon touching and/or releasing a virtual object with a portion of said element for touching and grasping virtual objects, characterized in that each interaction module is attached to said peripheral device through a connection in a damping material.

Advantageously, attaching the interaction modules through a connection in a damping material allows an attenuation or even cancellation of the vibratory propagations in the whole of the peripheral, and allows an operator to specifically localize the finger for which the vibrator is active. Thus the haptic or pseudo-haptic return is improved.

The interaction peripheral device according to the invention may have one or several of the features below, taken independently and individually or as a combination:

said interaction modules are mounted with a spacing between them of at least one predetermined distance;

it includes a structure made of at least two portions, capable of being attached together, said interaction modules being attached to one of said portions through a connection in a damping material with a predetermined maximum thickness;

said damping material is a material with a Shore A hardness of less than or equal to fifty;

each interaction module further includes a pressure sensor, capable of delivering a signal representative of the pressure exerted by the operator and of exerting a resistance to the pressure force exerted by the operator;

is further includes a handle capable of sensing forces applied by the palm of the operator, connected to a device controlling the displacement of the wrist of the operator, and mobile in a number of degrees of freedom relatively to said device, said device being capable of sending displacement commands to the element for touching and grasping virtual objects;

the device controlling the displacement of the wrist of the operator is further capable of providing a force and torque control of the wrist of the operator;

said control sensor is capable of sensing bending/extending displacements of a phalanx of the finger of the operator;

said control sensor is further capable of sensing adduction/abduction displacements of a phalanx of the finger of the operator;

it includes four interaction modules intended to be actuated by the thumb, the forefinger, the middle finger and the ring finger of the operator, the element for touching and grasping virtual objects being a virtual hand, each interaction module being capable of controlling the corresponding finger of the virtual hand;

upon clasping a virtual object by actuating a finger of the operator on an interaction model, the following operational succession of the sensors of said interaction module is applied:
activation of the control sensor until contact with said virtual object,
deactivation of the control sensor and activation of the vibrator,
activation of the pressure sensor;

upon loosening a virtual object by actuating a finger of the operator on an interaction module, the following operational succession of the sensors of said interaction module is applied:
activation of the pressure sensor until a sensitivity threshold of said pressure sensor is attained,
deactivation of the pressure sensor and activation of the vibrator,
activation of the control sensor.

Other features and advantages of the invention will become apparent from the description thereof which is given below as an indication and by no means as a limitation, with reference to the appended figures, wherein:

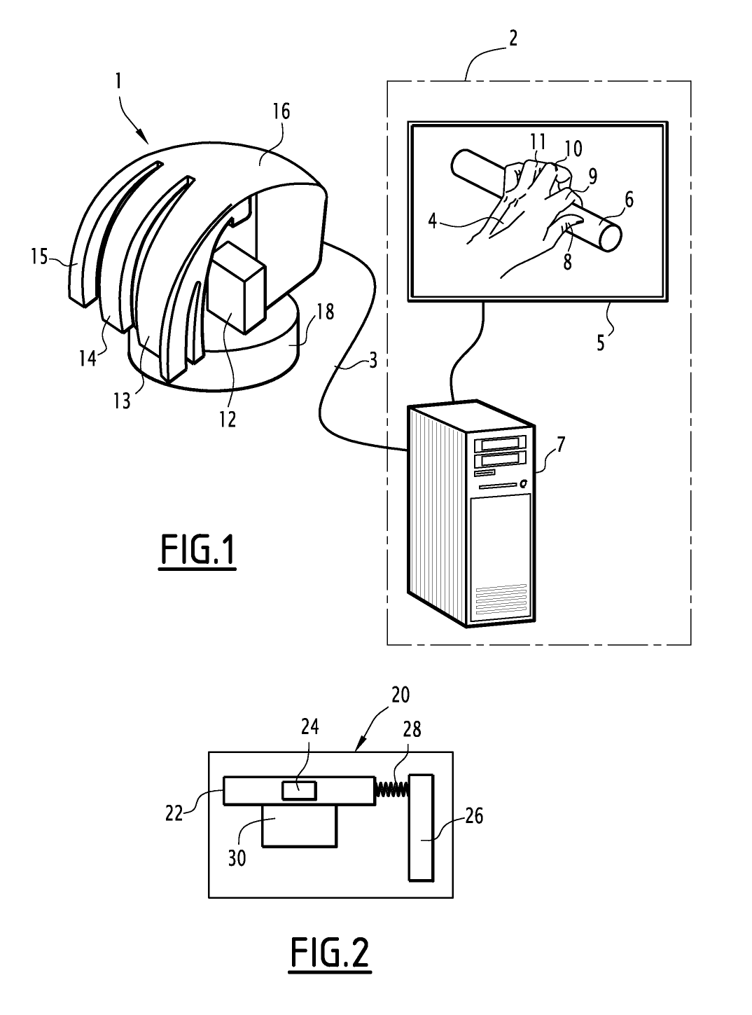

FIG. 1 illustrates a schematic view of an interaction peripheral device according to the invention, connected to a computer provided with a screen;

FIG. 2 schematically illustrates an interaction module in a top view;

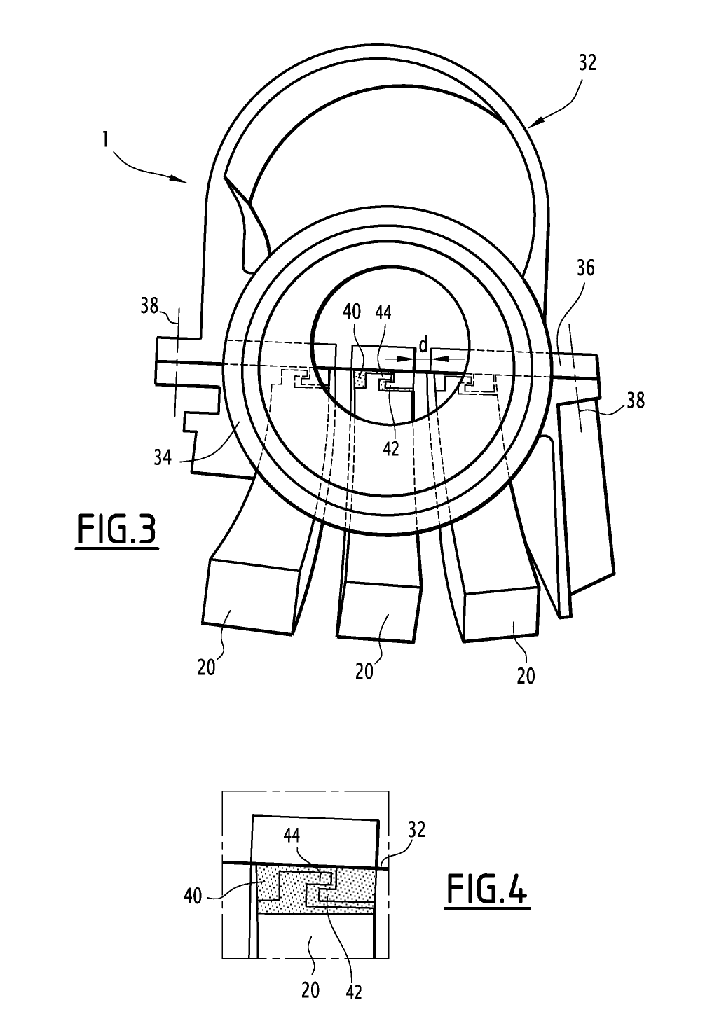

FIG. 3 illustrates a bottom view of an embodiment of an interaction peripheral device according to the invention, and

FIG. 4 illustrates an alternative embodiment of an interaction module connection according to the invention.

FIG. 1 illustrates an interaction peripheral device 1 connected to a computer 2 via a connection 3.

As illustrated in FIG. 1, the peripheral device 1 according to the invention is adapted so that a hand of an operator (not shown) is laid thereon in order to manipulate a touching and grasping element 4 which is a virtual hand in this example. The virtual hand 4 is illustrated on the screen 5 of the computer 2. The virtual hand 4 is able to move in the virtual space illustrated on the screen 5, and for example touch, turn, grasp, release, move the virtual object 6 which is two-dimensional or three-dimensional, displayed via an adequate display interface.

The screen 5 of the computer 2 is connected to a programmable device 7 including standard processing units, notably an analog/digital converter capable of recovering control signals transmitted through the connection 3 and of transforming them into information on the displacement of the virtual hand 4 on the screen 5, on the characterization of the contact between the fingers of the virtual hand and a virtual object, on the pressure between the fingers of the virtual hand and the virtual object. The programmable device 7 also includes a data processor, capable of performing calculation operations when the computer 2 is switched on.

The virtual hand 4 comprises a plurality of virtual fingers, at least one portion of which may be activated by the fingers of the operator positioned on the interaction peripheral device 1. Thus, the fingers referenced as 8, 9, 10, 11 of the virtual hand 4 may be activated in this example, respectively corresponding to the thumb, the forefinger, the middle finger and the ring finger of the virtual hand, each of these fingers being actuated by a corresponding interaction module of the peripheral device 1.

Thus, the peripheral device 1 comprises the following interaction modules: the module 12 corresponding to the thumb 8, the module 13 corresponding to the forefinger 9, the module 14 corresponding to the middle finger 10 and the module 15 corresponding to the ring finger 11.

Other layouts are alternatively possible.

For example, the peripheral device 1 may comprise a variable number of interaction modules between two and five, each interaction module being controlled by a finger of the operator.

According to one alternative, the number of portions (for example the number of fingers of the virtual hand) of the touching and grasping element 4 which may be actuated by the interaction modules is different from the number of interaction modules. For example, in one embodiment, the touching and grasping element 4 is a five-finger virtual hand but the ring finger and the little finger of the virtual hand 4 are actuated by the same interaction module 15 actuated by the ring finger of the operator.

The peripheral device 1 includes, in addition to the interaction modules adapted so as to be controlled by the fingers, and more specifically in this embodiment, the ends of the fingers corresponding to the last phalanx, a portion or handle 16 adapted for receiving the palm of the hand of the operator as well as his/her little finger.

The whole of the interaction modules 12, 13, 14, 15 and the handle 16 are mounted on a device 18 ensuring the movement of the wrist of the operator and determining the position and the orientation of the hand of the operator in space, with a predetermined number of degrees of freedom. For example, the device 18 is a 3-D mouse of the SpaceNavigator (registered trademark) type with a number of degrees of freedom equal to six.

Alternatively, and depending on the targeted application, it is possible to use a device 18 with which the position and the orientation of the hand of the operator in space may be obtained with less than six degrees of freedom.

In this embodiment, the movements of the ends of the fingers and of the palm of the hand of the operator relatively to his/her wrist are transmitted to the device 18, which transmits this movement information, as control signals, to the computer 2 via the wired connection 3.

In an alternative embodiment, the device 18 is further able to provide control of the force and torque applied to the wrist of the operator and during the manipulation, and provide this force and torque information, as control signals, to the computer 2.

A piece of software applying a model for the virtual hand articulation, applied in the programmable device 7 of the computer 2, allows these control signals to be transformed in order to restore the movement of the operator in the virtual hand 4. For example, such an articulation model is described in the article “Interactions Capture and Synthesis” ACM Transactions on Graphics, (2006), pp 872-880, by P. Kry and D. K. Pai.

In particular, in order to achieve the grasping of a virtual object, in order to grasp it, move it or turn it over for example, pressure forces applied by the ends of the fingers of the operator are sensed via the system explained above and interpreted.

The peripheral device 1 according to the invention, comprises several interaction modules, each interaction module being able to receive pressure from the end of the finger of the operator, according to a bending/extending or adduction/abduction movement for controlling the grasping of a virtual object, and to send back a tactile return so as to improve the perception of the operator and to make grasping of the virtual object more realistic.

FIG. 2 illustrates a schematic top view of an interaction module 20 according to the invention.

Such an interaction module 20 includes a control sensor or control unit 22, which is a sensor of the mono-axial lever type in the preferred embodiment, including a protruding portion 24 on which the end of the finger of the operator directly acts.

A sensor of the mono-axial lever type has the advantage of being a sensor of the switch type, receiving a command of the “all or nothing” type, allowing control of the movement velocity of the phalanx which actuates it. It is sufficient to release the control sensor so as to return it to its initial position, and the virtual finger controlled by the control sensor stops. This sensor ensures the bending/extending movements of the corresponding finger, except for the little finger for which the control is the same as that for the ring finger in the embodiment of FIG. 1, in which the peripheral device 1 comprises four interaction modules. Advantageously, a small movement amplitude of the finger of the operator allows the virtual finger to be controlled.

According to an alternative embodiment, the control sensor is applied with a control ball, known as a “mini-trackball”, which may manage the bending/extending and adduction/abduction movements and of the finger of the operator. Thus, in this alternative embodiment, more degrees of freedom of the displacement of a phalanx of the operator are taken into account. The control of the finger may then be achieved in displacement from the displacement of the phalanx which actuates it.

The interaction module 20 also includes a pressure sensor 26, for example of the resistive type, capable of delivering a representative signal of the pressure exerted by the finger of the operator on this module, in order to generate a compression force from the operator upon grasping a virtual object, similarly to grasping a natural object.

A return spring 28 between the control sensor 22 and the pressure sensor 26 allows separation of the pressure sensor 26 from the control sensor 22. The return spring 28 is optional.

Further, the interaction module 20 includes a vibrator 30, for example of the buzzer type of a portable telephone, able to emit a vibration for a short period following the contact of a virtual finger controlled by the control sensor 22 with a virtual object. According to an embodiment, the vibration period is of the order of half a second.

According to an alternative embodiment, the vibration lasts for a variable time depending on the analysis of the configuration of the hand made in the programmable device 7, and the deactivation of the vibrator 30 is triggered depending on the state of the pressure sensor 26.

Thus, during a phase for grasping or clamping a multidimensional virtual object, an operator manipulates the control sensor 22, while providing a very small force for actuating it. The corresponding virtual finger is brought closer to the virtual object to be grasped.

As soon as contact is established, the control sensor 22 is deactivated, and the vibrator 30 generates a vibration, allowing the operator to perceptually apprehend the change in state of the virtual finger. Deactivation of the control sensor 22 avoids interpenetration of the controlled virtual finger with the grasped virtual object. The pressure sensor 26 is actuated, opposing passive resistance which allows the operator to develop an increasing clamping force and during the clamping phase. The clamping force is limited by the maximum capacity of the pressure sensor 26, the control sensor 22 being already inactive.

This operating principle is applicable to any finger, independently of the others, thus giving the possibility of reproducing all the natural configurations for grasping objects.

Within the scope of an operation for releasing or loosening a virtual object, the succession for activating the diverse elements of the interaction module 20 is the following. Initially, the virtual hand is in contact with the virtual object, therefore in particular one of the virtual fingers is in contact with the virtual object and the pressure sensor 26 of the corresponding interaction module 20 is active.

When a sensitivity threshold of the pressure sensor 26 is reached, corresponding to the minimum capacity of the pressure sensor 26, the pressure sensor 26 is deactivated and the control sensor 22 is activated. This allows control of the displacement velocity of the finger corresponding to its separation from the virtual object. In an embodiment, the vibrator 30 is activated when the pressure sensor 26 is deactivated. Alternatively, the vibrator 30 is inactive during the operation for letting go of a virtual object.

The operation described above by an interaction module is quasi-simultaneously applied to all the interaction modules for controlling the whole of the virtual fingers of the virtual hand during a phase for grasping/clamping or releasing/loosening a virtual object.

It is noted that the behavior of the interaction peripheral device according to the invention is of the pseudo-haptic type, the applied forces not depending on the mass of the grasped virtual object.

According to an embodiment, the interaction peripheral device may be connected to a device 18 for displacement of the wrist and for controlling the force and torque on the wrist corresponding to a haptic arm capable of delivering forces corresponding to the mass of the manipulated object and to its dynamic behavior. In such an embodiment, the complete device including the haptic arm and the interaction peripheral device according to the invention is of the haptic type.

FIG. 3 illustrates a bottom view of an embodiment of an interaction peripheral device 1 according to the invention.

The peripheral device 1 includes, in this embodiment, a structural shell 32 formed with two portions 34 and 36, joined together by attachment means, such as for example screws 38. The portion 34 receives the interaction modules 20 described above. The interaction modules are integrated to the portion 34 of the shell 32, spaced apart with a predetermined minimum distance d, of the order of 5 mm plus or minus 2 mm, so as to avoid any contact and any vibratory diffusion between the modules.

Alternatively, the structural shell 32 is formed or in a single portion, by molding for example.

According to another alternative, the structural shell 32 is formed of a number of portions greater than two, for example depending on ergonomic or manufacturing constraints.

Each interaction module 20 is connected to the shell 32 through a connection 40 in a damping material with the low Shore A hardness, typically less than or equal to 50, positioned on a predetermined maximum thickness, of the order of 5 mm, this value having been retained so as to not make the mass heavier of the peripheral device 1. Preferably, the damping material used for the connection is a silicone or else polyurethane resin, the physical characteristics of which provide high damping of vibrations, while allowing good haptic return, with a sufficiently low mass so as not to burden the peripheral device 1. The silicone or polyurethane resin is used between the shell 32 and each interaction module 20. The damping material is adhesively attached between each interaction module 20 and the shell 32.

The selection of the damping material, its hardness and its thickness distribution are determined experimentally in order to meet the goals for damping vibrations, for transmitting force or haptic return per module, and for good adhesion. In particular the selected damping material has sufficient stiffness for good transmission of force while providing sufficient damping.

In the illustrated embodiment, each interaction module 20 is attached to the structural shell 32 with attachment elements of the small hook type 42, 44, which are nested. The thickness of the connection 40 in a damping material is less than the predetermined maximum thickness at the interstices between the hooks 42 and 44, for example the order of 2 mm.

Any other system for attaching the interaction module 20 to the structural shell 32 may be alternatively contemplated, the common point of the diverse possible embodiments being the presence of a connection 40 in a damping material.

An alternative embodiment of the connection 40 is illustrated in FIG. 4. In this alternative embodiment, the damping material forming the connection 40 covers the mechanical attachment hooks 42, 44, over a predetermined thickness, which is greater than or equal to 5 mm.

According to another alternative embodiment, the resin is extended to the whole shell 32 in order to damp vibrations between the palm of the hand and this shell 32.

Each connection 40 in a damping material is independent of the others, so as to avoid any contact between two interaction modules with each other, in order to improve the damping of vibrations between interaction modules. Preferably, a distance of the order of 5 mm is provided between the connections in a damping material.

Thus, vibratory insulation is achieved.

In an embodiment of the shell 32 in two portions, each portion includes a recess and when they are joined, they form a dome-shaped recess able to receive the device 18 (not shown in the figure).

In an embodiment, the portion 34 of the shell 32 intended to receive the interaction modules includes pre-machined locations provided for mounting the interaction modules. Advantageously, vibratory insulation is thereby obtained, which allows transmission to the operator of a tactile sensation correlated with the finger which applies the contact, which then allows the operator to finely adjust his/her manipulation.

1. An interaction peripheral device capable of controlling an element for touching and grasping multidimensional virtual objects, including at least two interaction modules, each interaction module being intended to be actuated by a finger of an operator and including a control sensor with which a displacement may be controlled according to a predetermined number of degrees of freedom, of a portion of the element for touching and grasping of virtual objects, by bending/extending and/or adduction/abduction displacement of the finger of the operator and a vibrator able to emit a vibration upon touching and/or letting go of a virtual object by a portion of said element for touching and grasping virtual objects, wherein each interaction module is attached to said peripheral device through a connection in a damping material.

2. The interaction peripheral device according to claim 1, wherein said interaction modules are mounted with a spacing between them of at least one predetermined distance d.

3. The interaction peripheral device according to claim 1, comprising a structure in at least two portions, capable of being attached together, said interaction modules being attached to one of said portions through a connection in a damping material with a predetermined maximum thickness.

4. The interaction peripheral device according to claim 1, wherein said damping material is a material with a Shore A hardness of less than or equal to fifty.

5. The interaction peripheral device claim 1, wherein each interaction module further includes a pressure sensor, capable of delivering a representative signal of the pressure exerted by the operator and of exerting resistance to the pressure force exerted by the operator.

6. The interaction peripheral device according to claim 1, further comprising a handle capable of sensing forces applied by the palm of the operator, connected to a device controlling the displacement of the wrist of the operator, and mobile in a number of degrees of freedom relatively to said device, said device of being capable of sending displacement commands to the element for touching and grasping virtual objects.

7. The interaction peripheral device according to claim 6, wherein the device controlling displacement of the wrist of the operator is further capable of providing a force and torque control of the wrist of the operator.

8. The interaction peripheral device according to claim 1, wherein said control sensor is able to sense bending/extending displacements of a phalanx of the finger of the operator.

9. The interaction peripheral device according to claim 8, wherein said control sensor is further able to sense adduction/abduction displacements of a phalanx of the finger of the operator.

10. The interaction peripheral device according to claim 1, including four interaction modules intended to be respectively actuated by the thumb, the forefinger, the middle finger and the ring finger of the operator and in that the element for touching and grasping virtual objects is a virtual hand, each interaction module being able to control the corresponding finger of the virtual hand.

11. The interaction peripheral device according to claim 5, wherein, upon clamping a virtual object by actuating a finger of the operator on an interaction module, the following operational succession of the sensors of said interaction module is applied:
activation of the control sensor until contact with said virtual object,
deactivation of the control sensor and activation of the vibrator,
activation of the pressure sensor.

12. The interaction peripheral device according to claim 5, wherein, upon loosening a virtual object by actuating a finger of the operator on an interaction module, the following operational succession of the sensors of said interaction module is applied:
activation of the pressure sensor until a sensitivity threshold of said pressure sensor is reached,
deactivation of the pressure sensor and activation of the vibrator,
activation of the control sensor.
